(19) United States
(12) Patent Application Publication
(10) Pub. No.: US 2017/0017480 A1
(43) Pub. Date: Jan. 19, 2017

(54) METHOD AND APPARATUS FOR UPDATING AN APPLICATION IN A USER TERMINAL

(71) Applicant: BEIJING QIHOO TECHNOLOGY COMPANY LIMITED, Beijing (CN)

(72) Inventor: Ting ZHANG, Beijing (CN)

(21) Appl. No.: 15/102,363

(22) PCT Filed: Dec. 10, 2014
(86) PCT No.: PCT/CN2014/093422

§ 371 Date: Jun. 7, 2016

(30) Foreign Application Priority Data
Dec. 10, 2013 (CN) 201310667593.2

(51) Int. Cl. G06F 9/445; H04L 29/08

(52) U.S. Cl. CPC G06F 8/65; H04L 67/26; H04L 67/34; G06F 8/61

(57) ABSTRACT

The invention discloses a method for updating an application in a user terminal, comprising: acquiring information of an application installed by a user in a terminal; and sending the information of the application installed by the user in the terminal to a server to be stored in an account of the user; wherein the information of the application is used for being pushed by the server to another terminal used by the user. In addition, the invention further discloses an apparatus for updating an application in a user terminal. With the invention, when a user installs a new application and/or updates an installed application in a terminal used by him, the user may be prompted to install and/or update the same application in other terminal used by him.

### FIELD OF THE INVENTION

The invention relates to the field of computer network, and in particular, to a method, apparatus, computer program and computer readable medium for updating an application in a user terminal.

### BACKGROUND OF THE INVENTION

Nowadays, computers and mobile terminals (for example, mobile phones, PADs, etc.) have become a very important tool in people's lives. Most people not only use computers, but also use mobile terminals, and many applications not only have versions for use with computers, but also have versions for use with mobile terminals. For a user, if he not only uses a computer, but also uses a mobile terminal, he will generally install one and the same application in the computer and the mobile terminal. For example, many people use SKYPE tools, the SKYPE and some games on computers, and will also install the SKYPE tools, the SKYPE and some identical games on mobile phones and PADs. Now, applications that are convenient to users are increasing, and if a user has installed 7 applications on a computer, and if he also wants to install these 7 applications on a mobile phone, he needs to download and install mobile phone versions of the 7 applications on the mobile phone, respectively. The more applications that need to be installed are, the more time that the user spends is, since the user needs to search for the applications one by one, and then choose to download and install them one by one. Therefore, there is a need for a simple and convenient method, which is such that common applications between a computer and a mobile terminal or between mobile terminals can be automatically prompted to be downloaded and installed.

### SUMMARY OF THE INVENTION

In view of the above problems, the invention is proposed to provide a method, apparatus, computer program and computer readable medium for updating an application in a user terminal, which overcome the above problems or at least in part solve the above problems.

According to an aspect of the invention, there is provided a method for updating an application in a user terminal, comprising: acquiring information of an application installed by a user in a terminal; and sending the information of the application installed by the user in the terminal to a server to be stored in an account of the user; wherein the information of the application is used for being pushed by the server to another terminal used by the user.

According to another aspect of the invention, there is provided a method for updating an application in a user terminal, comprising: allocating an account to a user according to a registration request from the user; receiving information of installed applications transmitted from individual terminals used by users, respectively; storing the information of the applications according to user accounts, respectively; and pushing information of applications stored in the individual user accounts to individual terminals of the individual users, respectively.

According to yet another aspect of the invention, there is provided an apparatus for updating an application in a user terminal, comprising: a processor configured to collect information of an application installed by a user in a terminal; and send the information of the application to a server to be stored in an account of the user; wherein the information is used for being pushed by the server to another terminal used by the user.

According to still another aspect of the invention, there is provided an apparatus for updating an application in a user terminal, comprising: a processor configured to allocate an account to a user according to a registration request from the user; receive information of installed applications transmitted from individual terminals used by users, respectively; store the information of the applications according to user accounts, respectively; and push information of applications stored in the individual user accounts to individual terminals of the individual users, respectively.

According to another aspect of the invention, there is provided a computer program comprising a computer readable code which causes the method for updating an application in a user terminal to be performed, when said computer readable code is run by an electronic device.

According to still another aspect of the invention, there is provided a computer readable medium storing the computer program as described above.

With the invention, when a user installs a new application and/or updates an installed application in a terminal used by him, the user may be prompted to install and/or update the same application in another terminal used by him.

The above description is merely an overview of the technical solutions of the invention. In the following particular embodiments of the invention will be illustrated in order that the technical means of the invention can be more clearly understood and thus may be embodied according to the content of the specification, and that the foregoing and other objects, features and advantages of the invention can be more apparent.

### BRIEF DESCRIPTION OF THE DRAWINGS

Various other advantages and benefits will become apparent to those of ordinary skills in the art by reading the following detailed description of the preferred embodiments. The drawings of the embodiments are only for the purpose of showing the preferred embodiments, and are not considered to be limiting to the invention. And throughout the drawings, like reference signs are used to denote like components. In the drawings:

FIG. 1 shows a flow chart of a method for updating an application in a user terminal according to an embodiment of the invention;

FIG. 2 shows a block diagram of an apparatus for updating an application in a user terminal according to an embodiment of the invention;

FIG. 3 shows a block diagram of a server according to an embodiment of the invention;

FIG. 4 shows a block diagram of a system for updating an application according to an embodiment of the invention;

FIG. 5 shows a block diagram of an electronic device for performing a method according to the invention; and

FIG. 6 shows a schematic diagram of a storage unit for retaining or carrying a program code implementing a method according to the invention.

### DETAILED DESCRIPTION OF THE INVENTION

In the following exemplary embodiments of the disclosure will be described in more detail with reference to the accompanying drawings. While the exemplary embodiments of the disclosure are shown in the drawings, it will be appreciated that the disclosure may be implemented in various forms and should not be limited by the embodiments set forth herein. Rather, these embodiments are provided in order for one to be able to more thoroughly understand the disclosure and in order to be able to fully convey the scope of the disclosure to those skilled in the art.

With the popularization of computers, networks and mobile terminals, a user may use multiple terminals at the same time. For example, a user uses a computer at home, but the user also uses a computer at office, and further uses a mobile phone and an IPAD. And yet the user may have installed different applications in different terminals. However, for some applications, the user hopes that they are also installed in other terminal. For example, a user installs the SKYPE on his home computer for daily communications with friends, but he also uses the SKYPE for work exchange, and therefore, when he is at office, he hopes that the SKYPE is also installed on a computer of the office. In addition, he hopes he can also use the SKYPE for communicating with colleagues or friends not in the office environment, such as on the way to and from work, and therefore, he also wants to install a mobile phone version of the SKYPE and a PAD version of the SKYPE in mobile terminals such as his mobile phone and IPAD, etc., respectively.

The usual practice is to search in different terminals for different applications installed therein, and then download and install them, respectively. In a situation in which there are many applications that need to be downloaded and installed, it is necessary to compare applications installed in different terminals, search in different terminals for applications to be downloaded, and then download and install them, for which it takes much time. To this end, there are provided a method and apparatus for updating an application between different user terminals of the invention.

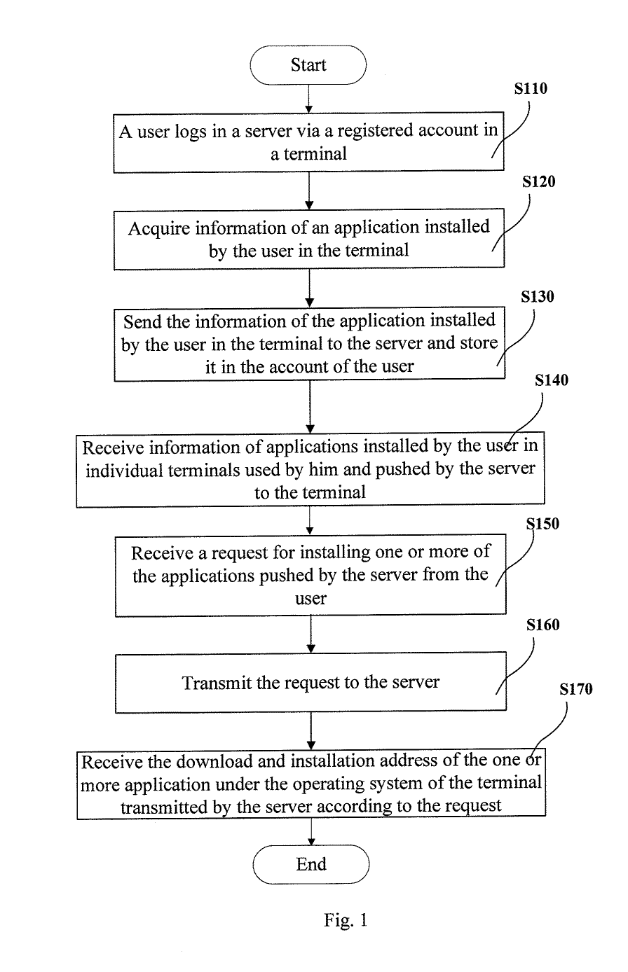

FIG. 1 shows a flow chart of a method for updating an application in a user terminal according to an embodiment of the invention. The method 100 for updating an application in a user terminal of the invention is mainly implemented by means of a server (for example, a cloud server).

As shown in FIG. 1, the method 100 for updating an application in a user terminal of the invention begins at step S110. At the step S110, a user logs in a server via a registered account in a terminal.

Since applications used frequently by each user will be different according to personal habits, preferences and demands, etc., the applications installed by them in individually used terminals will also be different. For convenience of managing information of applications installed by different users in their used terminals, here an account registered with a server (e.g., a cloud server) by each user is used. Each user may apply for an account in the server, and the server is networked with individual terminal devices used by users. In particular, a user sends a registration request to a server, the server allocates an account to the user based on the registration request and returns it to the user, and later after the user sends a login request via the account and the request passes the verification by the server, he may log in a space allocated by the server to him, for example, a cloud disk applied for by the user. On one hand, this facilitates management of information of related applications of different users by the server side, and on the other hand, also has confidentiality.

A user may use two or more terminals at the same time, and the terminals here comprise computers and mobile terminals (e.g., mobile phones, PADs, etc.), etc. The user logs in one and the same server via an account registered with the server by him in each terminal used by him. For example, a user A uses 4 terminals, a home computer, an office computer, an IPHONE mobile phone, and a Samsung mobile phone. Then, the user logs in one and the same server, e.g., a cloud server, via one and the same account in the 4 terminals. Thus, the 4 terminals used by the user may be interconnected by the cloud server.

Next, at step S120, information of an application installed by the user in the terminal is acquired. The information of an application comprises the name, version number, etc. of the application.

For example, the user A installs in the home computer applications: the MSN, a Kuwo music box, a parity device; installs in the office computer the SKYPE, the 360 secure browser; installs in his Iphone mobile phone the SKYPE, the Easecredit, a financial little helper; and installs in his Samsung mobile phone the 360 secure browser, a parity device, as shown in the following table 1.

TABLE 1

| | | | Apple | Samsung |
|---|---|---|---|---|
| | Home | Office | mobile | mobile |
| Name of software | PC | PC | phone | phone |
| SKYPE | | Yes | Yes | |
| Easecredit | | | Yes | |
| 360 secure browser | | Yes | | Yes |
| Parity device | Yes | | | Yes |
| Financial little | | | Yes | |
| helper | | | | |
| MSN | Yes | | | |
| Kuwo music box | Yes | | | |

Then, names of the three applications, the MSN, the Kuwo music box, the parity device, are acquired in the home computer; names of the two applications, the SKYPE, the 360 secure browser, are acquired in the office computer; names of the three applications, the SKYPE, the Easecredit, the financial little helper, are acquired in his IPHONE mobile phone; and names of the two applications, the 360 secure browser, the parity device, are acquired in his Samsung mobile phone.

Next, at step S130, the information of the application installed by the user in the terminal is sent to a server and stored in an account of the user registered with the server.

As in the example given at the step S120, the information of an application uploaded from the home computer to a server is the name of the application installed in the home computer, namely, the MSN, the Kuwo music box, and the parity device. The information of an application uploaded from the office computer to a server is the name of the application installed in the office computer, namely, the SKYPE, and the 360 secure browser. The information of an application uploaded from his IPHONE mobile phone to a server is the name of the application installed in the IPHONE mobile phone: the SKYPE, the Easecredit, and the financial little helper. The information of an application uploaded from his Samsung mobile phone to a server is the name of the application installed in the Samsung mobile phone: the 360 secure browser, and the parity device.

Since applications installed by a user in different terminals used by him may be different, the information of the application uploaded from a different terminal used by the user to a server is also different. However, information of applications uploaded from different terminals to a server is uniformly stored in an account of the user registered with the server for unified management, for example, establishing a uniformly managed database, in which information of applications from different terminals of individual users may be stored, and information of different users is stored according to accounts of the users, respectively.

In the above example, after receiving names of applications transmitted from the 4 terminals used by the user A, the server will aggregate the names of all the applications, and thereby learn about the names of all the applications used by the user A in the 4 terminals.

Next, at step S140, information of applications installed by the user in individual terminals used by him and pushed by the server to the terminal is received.

As in the example given at the step S130, the server pushes the names of all the applications used by the user A obtained by it to the 4 terminals of the user A, respectively, that is, pushes the SKYPE, the Easecredit, the 360 secure browser, the parity device, the financial little helper, the MSN, the Kuwo music box to the computer used at home, the computer used at office, the IPHONE mobile phone and the Samsung mobile phone of the user A, respectively.

Since the information of applications pushed by the server to individual terminals used by the user respectively is the summation of information of applications transmitted from the individual terminals used by the user to the server respectively, and yet there may be names of identical applications among the applications installed by the user in the different terminals used by him, if the names of repetitive applications were not removed, the names, etc. of two or more identical applications might be contained when pushing information of applications to individual terminals used by the user at the step S140. Therefore, de-repetition processing will be performed on the received information of applications from individual terminals of the user at the server side.

In addition, when the information of an application acquired at the step S120 contains the version number of the application, if the version numbers acquired from different terminals are different for one and the same application, all the versions of the application are stored in the account of the user when performing de-repetition processing, the user may select which version to be installed according to his own needs, and when the information of such an application is pushed to a terminal of the user where a lower version number of it is installed, the user may be prompted that the application needs to be updated in the terminal, and it is decided by the customer whether to install a new version.

In addition, at the server side, it may be possible to compare information of total applications used by a certain user which is received by the server with information of applications installed in individual terminals used by the user respectively, and find out applications that are not installed and/or applications that are not updated in individual terminals used by the user respectively, and thus, at the step S140, it may be possible to push to different terminals of the user information of applications that are not installed therein and/or information of applications that are not updated therein according to a comparison result, respectively. In such a situation, as in the example shown in the above table 1, the SKYPE, the Easecredit, the 360 secure browser and the financial little helper are pushed to the PC of the user A; the Easecredit, the parity device, the financial little helper, the MSN and the Kuwo music box are pushed to the office PC of the user A; the 360 secure browser, the parity device, the MSN and the Kuwo music box are pushed to the apple mobile phone of the user; and the SKYPE, the Easecredit, the financial little helper, the MSN and the Kuwo music box are pushed to the Samsung mobile phone of the user. Thus, it may be such that information of applications pushed to different terminals is more targeted, the user may know that the pushed applications are not installed in a currently used terminal without the need to perform comparison and screening, and he only needs to select whether it is necessary for him to install them, thereby reducing the time with which the user performs search and comparison.

In addition, optionally, before performing the step S130, there may be further comprised step S125 (not shown in FIG. 1), at which information of the operating system used in the terminal is acquired. To facilitate the user to install a new application or update an installed application in a different terminal, it may be possible to acquire operating systems of different terminals used by the user. Since the operating systems used in different terminals are different, for example, the ISO operating system is used in an apple mobile phone, the Android operating system is used in a Samsung mobile phone, and the WINDOWS operating system, the LINUX operating system and the MAC operating system, etc. may be used in a computer, the version of an application installed under a different operating system will also be different. Accordingly, when performing the step S130, while information of applications installed by the user in the terminal is sent to the server, the information of the operating system used by the terminal is also sent to the server and stored in the account of the user. At this point, at the server side will be stored information of applications and information of operating systems used by terminals of the user, and will also be stored link addresses of individual applications in these operating systems respectively. Here, the server may acquire link addresses of individual applications and perform corresponding storage itself. For example, as for the example shown in the above table 1, the server side may store corresponding information according to the following table 2.

TABLE 2

| Name of | | | |
|---|---|---|---|
| software | PC | IOS | Adroid |
| SKYPE | Link address 11 | Link address 12 | Link address 13 |
| Easecredit | Link address 21 | Link address 22 | Link address 23 |
| 360 secure | Link address 31 | Link address 32 | Link address 33 |
| browser | | | |
| Parity device | Link address 41 | Link address 42 | Link address 43 |
| Financial | Link address 51 | Link address 52 | Link address 53 |
| little helper | | | |
| MSN | Link address 61 | Link address 62 | Link address 63 |
| Kuwo music | Link address 71 | Link address 72 | Link address 73 |
| box | | | |

Thus, at the step S140, when pushing information of an application to a terminal used by the user with a different operating system, the link address of the application under the operating system of the terminal is also pushed. For example, the following information is pushed to computers of the user A used at home and at office.

| | |
|---|---|
| SKYPE | Link address 11 |
| Easecredit | Link address 21 |
| 360 secure browser | Link address 31 |
| Parity device | Link address 41 |
| Financial little helper | Link address 51 |
| MSN | Link address 61 |
| Kuwo music box | Link address 71 |

The following information is pushed to the IPHONE mobile phone of the user A:

| Name of software | IOS |
|---|---|
| SKYPE | Link address 12 |
| Easecredit | Link address 22 |
| 360 secure browser | Link address 32 |
| Parity device | Link address 42 |
| Financial little helper | Link address 52 |
| MSN | Link address 62 |
| Kuwo music box | Link address 72 |

The following information is pushed to the Samsung mobile phone of the user A:

| Name of software | Adroid |
|---|---|
| SKYPE | Link address 13 |
| Easecredit | Link address 23 |
| 360 secure browser | Link address 33 |
| Parity device | Link address 43 |
| Financial little helper | Link address 53 |
| MSN | Link address 63 |
| Kuwo music box | Link address 73 |

The above information pushed to individual terminals may be displayed on a display interface of a computer in the form of a list, of which on the left is the name of an application, and on the right is the link address of the application correspondingly. In this case, when the user wants to install the application, a download and installation page of an application may be linked to by clicking the link address to the right of the name of the application. In addition, optionally, in the display form, the information may also take a form that combines the link address of an application and the name of the application together, that is to say, when the user wants to install a pushed application, he only needs to click the name of the application.

Accordingly, after the step S140, there may be further comprised steps S150-S170. At the step S150, a request for installing one or more of the applications pushed by the server from the user is received; next, at the step S160, the request is transmitted to the server; and next, at the step S170, the download and installation address of the one or more application under the operating system of the terminal transmitted by the server according to the request is received. As in the examples shown in the above table 1 and table 2, when the user clicks the link address to the right of an application, a request for installing the application will be sent out, the request for installing the application will be received at the step S150, and the request will be transmitted to the server at the step S160. After the server receives the request for installing the application from the user, at the step S170, according to the request, the server will send the download and installation address of the application consistent with the operating system of the user terminal to the user terminal to facilitate the user's download and installation, without the need for the user to further query about the download address of the application that he wants to install. As such, the time with which the user searches for the download address of the application.

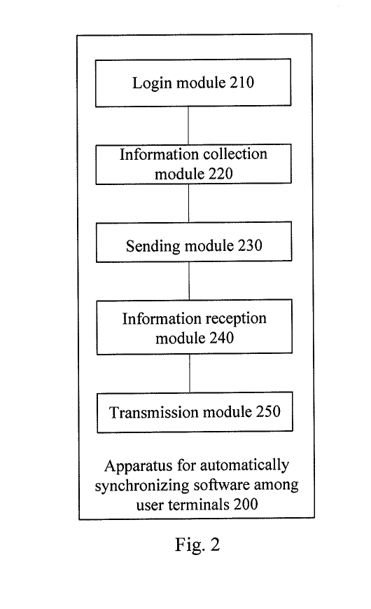

FIG. 2 shows an apparatus for updating an application in a user terminal according to an embodiment of the invention, which is disposed in each terminal used by a user. As shown in FIG. 2, the apparatus 200 for updating an application in a user terminal of the invention comprises a login module 210, an information collection module 220, a sending module 230 and an information reception module 240.

Therein, the login module 210 is configured for logging in a server by a user via an account registered with the server. Since applications used frequently by each user will be different according to personal habits, preferences and demands, etc., the applications installed by them in individually used terminals will also be different. For convenience of managing information of applications installed by different users in their used terminals, here an account registered with a server (e.g., a cloud server) by each user is used. Each user may apply for an account in the server, and the server is networked with individual terminal devices used by users. In particular, a user sends a registration request to a server, the server allocates an account to the user based on the registration request and returns it to the user, and later after the user sends a login request via the account and the request passes the verification by the server, he may log in a space allocated by the server to him, for example, a cloud disk applied for by the user. On one hand, this facilitates management of information of related applications of different users by the server side, and on the other hand, also has confidentiality.

A user may use two or more terminals at the same time, and the terminals here comprise computers and mobile terminals (e.g., mobile phones, PADs, etc.), etc. The user logs in one and the same server via an account registered with the server by him in each terminal used by him. Thus, the two or more terminals used by the user are interconnected by the server.

The information collection module 220 is configured for acquiring information of an application installed by the user in the terminal. Here, the information of an application comprises the name, version number, etc. of the application. When the user uses multiple terminals, in each of the terminals used by the user, the information collection module 220 acquires information of an application installed by the user in the terminal where it is located.

The sending module 230 is configured for sending the information of the application installed by the user in the terminal which is obtained by the information collection module 220 to a server and storing it in an account of the user registered with the server. Since applications installed by a user in different terminals used by him may be different, the information of the application transmitted from the sending module 230 located in a different terminal used by the user to a server is also different. However, information of applications uploaded from different terminals to a server is uniformly stored in an account of the user registered with the server for unified management, for example, establishing a uniformly managed database, in which information of applications from different terminals of different users may be stored, and information of different users is stored according to accounts of the users, respectively.

The information reception module 240 is configured for receiving information of applications installed by the user in individual terminals used by him and pushed by the server to the terminal. After receiving information of applications sent by sending modules 230 in individual terminals used by the user, the server will aggregate the information of all the applications, get a total list of information of applications used by the user, and then push the total list of information of applications to individual terminals used by the user, respectively. By comparing the total list of information of applications with information of applications installed in a terminal currently used by him, it may be possible to know which applications have already been installed and which applications have not been installed in the currently used terminal, without the need for comparing information of applications installed in the currently used terminal with information of applications installed in other terminals used by him, respectively, and therefore the time with which the user searches for and installs an application that he prefers may be saved.

In addition, the information collection module 220 may further acquire information of the operating system used in the terminal. To facilitate the user to install a new application or update an installed application in a different terminal, it may be possible to acquire operating systems of different terminals used by the user. Since the operating systems used in different terminals are different, and the version of an application installed under a different operating system will be different, even for one and the same application, the versions of the application installed in different terminals will also be different due to different operating systems. Accordingly, the sending module 230 also sends the information of the operating system used by the terminal which is acquired by the information collection module 220 to the server and it is stored in the account of the user. At this point, at the server side, in the total list of information of applications of the user will be stored information of applications and information of operating systems used by terminals of the user, and will also be stored link addresses of individual applications in these operating systems respectively. Here, the server may acquire link addresses of individual applications and perform corresponding storage itself.

In addition, the apparatus 200 of the invention may further comprise a transmission module 250, which is configured for receiving a request for installing one or more of the applications pushed by the server from the user, and transmitting the request to the server. In particular, the total list of information of applications of the user pushed by the server which is received by the information reception module 240 comprises download link addresses of individual applications. For example, when the user finds out by comparison that the currently used terminal has not an application in the list, the user clicks a download link address corresponding to an application, which at this point sends out a request for downloading and installing the application. The transmission module 250 receives the request from the user, and transmits it to the server. Afterwards, the information reception module 240 receives a download and installation page of the one or more application under the operating system of the terminal transmitted by the server according to the request. The user may download and install the application by click. This further facilitates the use by the user, and the user does not need to search for a download and installation page of an application to be installed by himself, which further saves time for the user to download and install the application.

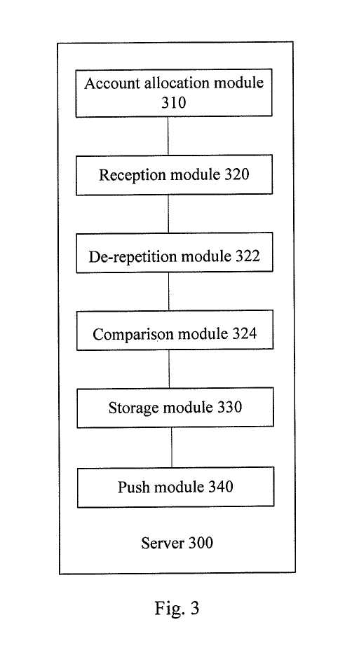

In addition, the invention further provides a server, as shown in FIG. 3, which shows a structural block diagram of a server 300 of the invention. The server 300 of the invention may comprise an account allocation module 310, a reception module 320, a storage module 330 and a push module 340.

Therein, the account allocation module 310 allocates an account to a user according to a registration request from the user. Each user may obtain a unique account by registering with the server. Afterwards, the user may access the server via the account in any one of the terminals used by him, and store its related information in the server, and thereby unified management of related information of different terminals of the user may be achieved. As described above, the user may use two or more terminals at the same time, and the terminals here comprise computers and mobile terminals (e.g., mobile phones, PADs, etc.), etc.

The reception module 320 is configured for receiving information of installed applications transmitted from individual terminals used by the user, respectively. As in the examples given in the above table 1 and table 2, when the user A uses 4 terminals, the reception module 320 receives, from the sending modules 230 in the 4 terminals of the user, information of applications installed in corresponding terminals which is transmitted by them, respectively. The reception module 320 not only receives related information transmitted by different terminals used by the same user, but also receives related information transmitted by different users from their individual terminals.

The storage module 330 is configured for storing information of applications received by the reception module 320 according to accounts of users, respectively. Since the server will receive information transmitted to it by multiple users, to facilitate unified management, the server side will establish a uniformly managed database, store information of each user according to the account of the user, store information of applications from different terminals used by each user in the account of the user, and aggregate information of these applications to form a total list of information of applications to be stored in the storage module 330. For example, it may be possible to store a total list of information of applications installed in terminals of the user. As in the examples given in the above table 1 and table 2, when the user A uses 4 terminals, the storage module 330 stores a total list of information of applications used by the user A in his 4 terminals.

The push module 340 is configured for pushing information of applications stored in accounts of individual users in the storage module 330 to individual terminals of the individual users, respectively. That is, a total list of information of applications with respect to a user stored in the storage module 330 is pushed to different terminals used by the user, respectively. As in the examples given in the above table 1 and table 2, when the user A uses 4 terminals, a total list of information of applications with respect to the user A is pushed to his 4 terminals, respectively.

In addition, preferably, the server 300 of the invention may further comprise a de-repetition module 322, which is configured for performing de-repetition processing on information of applications acquired by the reception module 320 from individual terminals.

Since one and the same application may have already been installed in different terminals used by the user, thus, the information of applications acquired by the reception module 320 from different terminals of the user may contain names of identical applications, and if the names of repetitive applications were not removed, the names of two identical applications would occur when the push module 340 pushes names of applications to terminals of the user, and the user experience would be poor. Therefore, after the reception module 320 acquires information of applications from individual terminals, the de-repetition module 322 had better perform de-repetition processing on the acquired information of applications. In addition, when the information of an application acquired by the reception module 320 contains the version number of the application, if the version numbers acquired from different terminals are different for one and the same application, all the versions of the application are stored in the account of the user when performing de-repetition processing, the user may select which version to be installed according to his own needs, and when the information of such an application is pushed to a terminal of the user where a lower version number of it is installed, the user may be prompted that the application needs to be updated in the terminal.

In addition, optionally, the server 300 of the invention may further comprise a comparison module 324. After the reception module 320 acquires information of applications from individual terminals, the comparison module 324 may compare the information of applications acquired by the reception module 320 with applications installed in individual terminals used by the user respectively, and obtain a comparison result, that is, find out applications that are not installed and/or applications that are not updated in individual terminals used by the user respectively, and store them in the storage module 330. After that, the push module 340 may push to corresponding terminals information of applications that are not installed and/or information of applications that are not updated in different terminals of the user according to the comparison result stored in the storage module 330, respectively, such that the pushed information of applications is more targeted, the user does not need to perform comparison and screening, and the user experience is further improved.

In addition, optionally, the reception module 320 may further receive information of operating systems installed in individual terminals used by the user respectively. Accordingly, the storage module 330 may further store the information of operating systems installed in individual terminals used by the user respectively that is received by the reception module 320 and download and installation addresses of individual applications under the operating systems.

To facilitate the user to install a new application or update an installed application in a different terminal, it may be possible to acquire operating systems of different terminals used by the user. Since the operating systems used in different terminals are different, and the version of an application installed under a different operating system will be different, even for one and the same application, the versions of the application installed in different terminals will also be different due to different operating systems. To this end, the reception module 320 may acquire the information of operating systems installed in individual terminals used by the user respectively, and acquire the download and installation addresses of individual applications used by the user under different operating systems, and then information of applications installed and used by the user, information of operating systems used by terminals of the user and link addresses of the applications installed and used by the user under the operating systems are stored in the total list of information of applications of the user, and stored in the storage module 330.

Accordingly, the reception module 320 in the server 300 may further receive a request for installing one or more of the applications pushed by the push module to a terminal used by the user, which is sent by the user from the user terminal. After the push module 340 sends the total list of information of applications containing the information of applications installed and used by the user, information of operating systems used by terminals of the user and link addresses of the applications installed and used by the user under the operating systems to individual terminals used by the user, the user clicks the link address of an application according to his own needs and sends a request for installing the application. After the reception module 320 receives the request for installing the application from the user, the push module 340 will send a download and installation page corresponding to the application to the user terminal for the user to select to download and install it, thereby providing convenience for a user in downloading and installing an application that he needs. In addition, the invention further provides a system for updating an application.

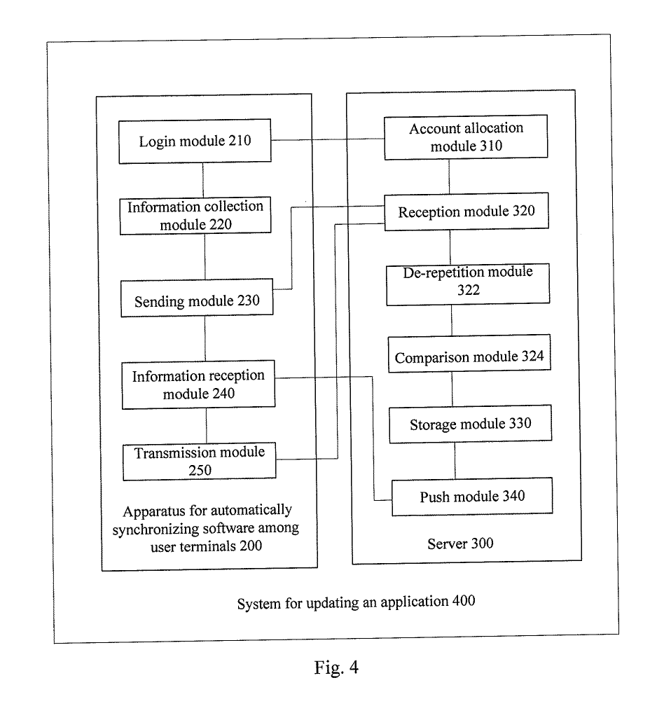

As shown in FIG. 4, the system 400 for updating an application of the invention comprises two or more terminals 410 used by a user and a server 300 as described above. Therein, the two or more terminals 410 used by the user comprise an apparatus 200 for updating an application in a user terminal as described above. Here, the server 300 and the apparatus 200 for updating an application in a user terminal have already been described in detail, and will not be repeated here for the sake of brevity.

With the invention, when a user installs a new application and/or updates an installed application in a terminal used by him, the user may be prompted to automatically install and/or update the same application in other terminal used by him. For example, when the user buys a new mobile phone, the invention may be utilized to install in the new mobile phone an application that exists in his original old mobile phone very conveniently and rapidly, or also it may be possible to install an application in other terminal used by him, which saves time for the user.

The algorithms and displays provided here are not inherently related to any specific computer, virtual system or other terminal. Various general-purpose systems may also be used with the teachings herein. According to the above description, the structure required for constructing such systems is obvious. In addition, the invention is not directed to any specific programming language. It should be understood that the content of the invention described herein may be carried out utilizing various programming languages, and that the above description for a specific language is for the sake of disclosing preferred embodiments of the invention.

In the specification provided herein, a plenty of particular details are described. However, it can be appreciated that an embodiment of the invention may be practiced without these particular details. In some embodiments, well known methods, structures and technologies are not illustrated in detail so as not to obscure the understanding of the specification.

Similarly, it shall be appreciated that in order to simplify the disclosure and help the understanding of one or more of all the inventive aspects, in the above description of the exemplary embodiments of the invention, sometimes individual features of the invention are grouped together into a single embodiment, figure or the description thereof. However, the disclosed methods should not be construed as reflecting the following intention, namely, the claimed invention claims more features than those explicitly recited in each claim. More precisely, as reflected in the following claims, an aspect of the invention lies in being less than all the features of individual embodiments disclosed previously. Therefore, the claims complying with a particular implementation are hereby incorporated into the particular implementation, wherein each claim itself acts as an individual embodiment of the invention.

It may be appreciated to those skilled in the art that modules in a device in an embodiment may be changed adaptively and arranged in two or more devices different from the embodiment. Modules or units or assemblies may be combined into one module or unit or assembly, and additionally, they may be divided into multiple sub-modules or sub-units or subassemblies. Except that at least some of such features and/or procedures or units are mutually exclusive, all the features disclosed in the specification (including the accompanying claims, abstract and drawings) and all the procedures or units of any method or device disclosed as such may be combined employing any combination. Unless explicitly stated otherwise, each feature disclosed in the specification (including the accompanying claims, abstract and drawings) may be replaced by an alternative feature providing an identical, equal or similar objective.

Furthermore, it can be appreciated to the skilled in the art that although some embodiments described herein comprise some features and not other features comprised in other embodiment, a combination of features of different embodiments is indicative of being within the scope of the invention and forming a different embodiment. For example, in the following claims, any one of the claimed embodiments may be used in any combination.

Embodiments of the individual components of the invention may be implemented in hardware, or in an application module running on one or more processors, or in a combination thereof. It will be appreciated by those skilled in the art that, in practice, some or all of the functions of some or all of the components in an apparatus for updating an application in a user terminal according to individual embodiments of the invention may be realized using a microprocessor or a digital signal processor (DSP). The invention may also be implemented as a device or apparatus program (e.g., a computer program and a computer program product) for carrying out a part or all of the method as described herein. Such a program implementing the invention may be stored on a computer readable medium, or may be in the form of one or more signals. Such a signal may be obtained by downloading it from an Internet website, or provided on a carrier signal, or provided in any other form.

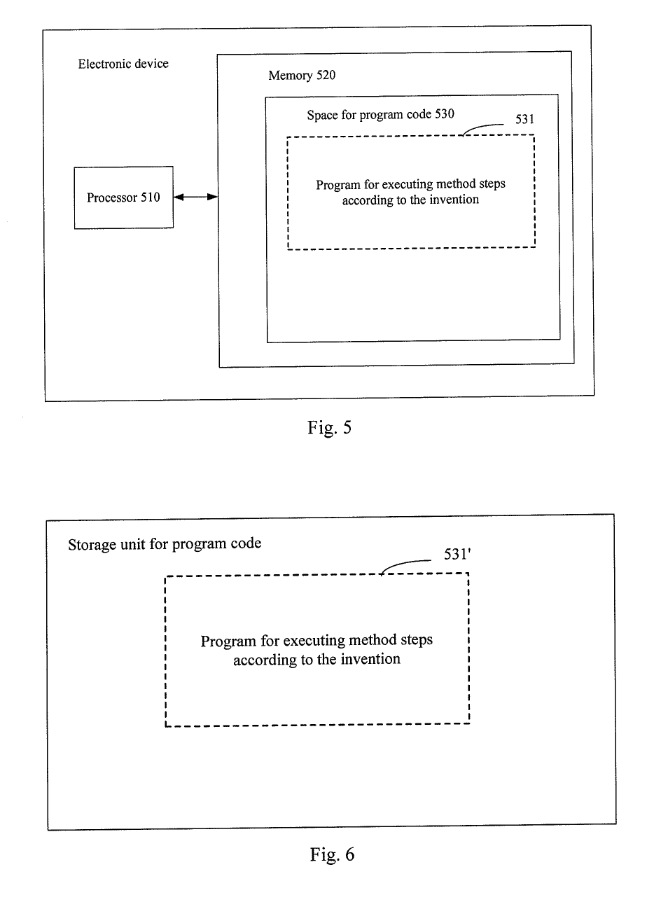

For example, FIG. 5 shows an electronic device which may carry out a method for updating an application in a user terminal of the invention. The electronic device traditionally comprises a processor 510 and a computer program product or a computer readable medium in the form of a memory 520. The memory 520 may be an electronic memory such as a flash memory, an EEPROM (electrically erasable programmable read-only memory), an EPROM, a hard disk or a ROM. The memory 520 has a memory space 530 for a program code 531 for carrying out any method steps in the methods as described above. For example, the memory space 530 for a program code may comprise individual program codes 531 for carrying out individual steps in the above methods, respectively. The program codes may be read out from or written to one or more computer program products. These computer program products comprise such a program code carrier as a hard disk, a compact disk (CD), a memory card or a floppy disk. Such a computer program product is generally a portable or stationary storage unit as described with reference to FIG. 6. The storage unit may have a memory segment or a memory space, etc. arranged similarly to the memory 520 in the electronic device of FIG. 5. The program code may for example be compressed in an appropriate form. In general, the storage unit comprises a program 531′ for executing method steps according to the invention, i.e., a code which may be read by e.g., a processor such as 510, and when run by an electronic device, the codes cause the electronic device to carry out individual steps in the methods described above.

It is to be noted that the detailed description of the invention in the above embodiments does not limit the invention, and those skilled in the art may design alternative embodiments without departing the scope of the appended claims. In the claims, any reference sign placed between the parentheses shall not be construed as limiting to a claim. The word “comprise” does not exclude the presence of an element or a step not listed in a claim. The word “a” or “an” preceding an element does not exclude the presence of a plurality of such elements. The invention may be implemented by means of a hardware comprising several distinct elements and by means of a suitably programmed computer. In a unit claim enumerating several apparatuses, several of the apparatuses may be embodied by one and the same hardware item. Use of the words first, second, and third, etc. does not mean any ordering. Such words may be construed as naming.

Furthermore, it is also to be noted that the language used in the description is selected mainly for the purpose of readability and teaching, but not selected for explaining or defining the subject matter of the invention. Therefore, for those of ordinary skills in the art, many modifications and variations are apparent without departing the scope and spirit of the appended claims. For the scope of the invention, the disclosure of the invention is illustrative, but not limiting, and the scope of the invention is defined by the appended claims.

1. A method for updating an application in a user terminal, comprising:
acquiring information of an application installed by a user in a terminal; and
sending the information of the application installed by the user in the terminal to a server to be stored in an account of the user;
wherein the information of the application is used for being pushed by the server to another terminal used by the user.

2. The method as claimed in claim 1, further comprising:
acquiring information of the operating system used in the terminal;
accordingly, the step of sending the information of the application installed by the user in the terminal to a server to be stored in an account of the user is to,
send the information of the application installed by the user in the terminal and the information of the operating system used by the terminal to the server and store them in the account of the user,
wherein in the account registered by the user with the server are stored the information of the operating system and the download and installation addresses of individual applications used by the user under the operating system respectively.

3. The method as claimed in claim 2, wherein before acquiring the information of the application installed by the user in the terminal, the method further comprises:
logging in the account of the user in the server in the terminal.

4. The method as claimed in claim 1, wherein
the terminal used by the user comprises a computer and a mobile terminal.

5. The method as claimed in claim 1, wherein
the information of the application comprises at least one of a name of the application and a version number of the application.

6.-10. (canceled)

11. An apparatus for updating an application in a user terminal, comprising:
a memory having instructions stored thereon; and
at least one processor configured to execute the instructions to perform operations for updating an application in a user terminal, the operations comprising:
collecting information of an application installed by a user in a terminal; and sending the information of the application to a server to be stored in an account of the user;
wherein the information is used for being pushed by the server to another terminal used by the user.

12. The apparatus as claimed in claim 11, the operations further comprising:
acquiring information of the operating system used in the terminal, and sending the information of the operating system to the server to be stored in the account of the user;
wherein in the account registered by the user with the server are stored the information of the operating system and the download and installation addresses of individual applications used by the user under the operating system respectively.

13. The apparatus as claimed in claim 12, the operations further comprising:
receiving a request for installing one or more of the applications pushed by the server from the user and transmitting the request to the server; and receiving the download and installation address of the one or more application under the operating system of the terminal, which is transmitted by the server according to the request.

14. The apparatus as claimed in claim 11, wherein
the information of the application comprises at least one of a name of the application and a version number of the application.

15. A server, comprising:
a memory having instructions stored thereon; and
at least one processor configured to execute the instructions to perform operations for updating an application in a user terminal, the operations comprising:
allocating an account to a user according to a registration request from the user; receiving information of installed applications transmitted from individual terminals used by users, respectively; storing the information of the applications according to user accounts, respectively; and pushing information of applications stored in the individual user accounts to individual terminals of the individual users, respectively.

16. The server as claimed in claim 15, the operations further comprising:
performing de-repetition processing on information of applications acquired from individual terminals used by the user.

17. The server as claimed in claim 15, the operations further comprising:
comparing the information of applications acquired from individual terminals used by the user with information of applications installed in individual terminals used by the user respectively, and finding out applications that are not installed and/or applications that are not updated in individual terminals used by the user respectively; and
storing a comparison result according to individual terminals used by the user and according to individual user accounts, respectively.

18. The server as claimed in claim 15, the operations further comprising:
receiving information of operating systems used respectively in individual terminals used by the user; and storing the information of operating systems used respectively in individual terminals used by the user and download and installation addresses of individual applications in individual terminals used by the user under the operating systems.

19. The server as claimed in claim 18, the operations further comprising:
receiving a request for installing one or more of the applications pushed to a terminal used by the user, which is sent by the user from the user terminal; sending to the terminal used by the user the download and installation address of the one or more application under the operating system of the terminal according to the received request from the user.

20.-21. (canceled)
